(19) United States
(12) Patent Application Publication
(10) Pub. No.: US 2023/0356162 A1
(43) Pub. Date: Nov. 9, 2023

(54) MICROWAVE-ASSISTED PYROLYSIS SYSTEM AND METHOD THEREOF

(71) Applicants: Mohd. Shkir, Abha (SA); KING KHALID UNIVERSITY, Abha (SA); Princess Nourah bint Abdurahman University, Riyadh (SA)

(72) Inventors: Anuj KUMAR, Mathura (IN); Mohd Ubaidullah, Riyadh (SA); S.M. Al-Moayid, Abha (SA); Mohd. Shkir, Abha (SA); Hamed Majdooa Algarni, Abha (SA); Thamraa Alshahrani, Riyadh (SA)

(21) Appl. No.: 18/345,328

(22) Filed: Jun. 30, 2023

(51) Int. Cl. B01J 6/00; B01J 19/12; B01J 19/02; B01J 19/00

(52) U.S. Cl. CPC B01J 6/008; B01J 19/126; B01J 19/02; B01J 19/0013; B01J 2203/00; B01J 2219/00141; B01J 2219/00076; B01J 2219/00065

(57) ABSTRACT

The present invention generally relates to a microwave-assisted pyrolysis system comprised of a microwave chamber body (102); a black carbon platform (104) disposed inside the microwave chamber body for irradiating microwave radiation and absorbing microwave energy; a quartz microwave reactor (106) placed on the black carbon platform for receiving chemical precursor(s) and applying microwave irradiation for absorption of microwave energy thereby heating the black carbon platform for microwave-assisted pyrolysis of the received chemical precursor(s); a cooling unit (108) employed for regulating and maintaining a user-defined temperature level upon detecting the temperature inside the microwave reactor using a temperature sensor (110), if the temperature exceeds the optimum level, wherein the optimum temperature is defined on the type of precursors undergoing pyrolysis; and wherein if the heating temperature is raised extremely high, the cooling unit inside the microwave machine gets activated to bring down the temperature to the user-defined level.

### FIELD OF THE INVENTION

The present disclosure relates to pyrolysis systems. In more detail, a microwave-assisted pyrolysis system and method using a black carbon platform.

### BACKGROUND OF THE INVENTION

Conventionally, pyrolysis is a process that brings chemical transformations of a chemical sample to a temperature ranging from 400 to 1000° C. Generally, a muffle furnace or tubular muffle furnace is used to conduct pyrolysis at a laboratory scale to prepare a variety of materials in the presence or absence of dioxygen. The mechanism involved in this process is the fragmentation of chemical species at the evaporation stage, followed by recombination to create new materials. However, conventional pyrolysis essentially requires high energy (electricity), yielding possible undesirable side products and sometimes unwanted morphological and structural changes in the desired product. Moreover, from an economic and environmental perspective, this protocol is not only expensive but also affects the environment severely due to the emission of carbonaceous gases.

In contrast, heating chemical precursors in microwave-assisted pyrolysis (MAP) is done with the help of the electric field component of an electromagnetic wave, MAP, a medium-speed pyrolytic process, involves a heating rate of nearly 50% of needed traditional pyrolysis. In MAP, the efficiency of pyrolysis of the targeted material's ability to absorb microwave radiation is based on the moisture content of the material. Moreover, in MAP, no external heating of material is required as the material gets dried via convection. Therefore, volumetric heating in MAP is far more efficient than electric-resistant heating in traditional pyrolysis. Despite multiple advantages, MAP still has a few challenges like non-uniform heating, inefficient energy consumption, and expenditure.

Conventional pyrolysis takes significant energy (electricity) and may produce unwanted side products and morphological and structural alterations in the target product. This procedure emits carbonaceous emissions, making it costly and harmful to the environment. MAP pyrolysis efficiency depends on material moisture and microwave radiation absorption. Volumetric heating in MAP is far more efficient than electric-resistant heating in classical pyrolysis. MAP has some drawbacks, including non-uniform heating, energy waste, and high costs.

In view of the foregoing discussion, it is portrayed that there is a need to have a key modification in MAP set-up, to use carbon black-platform, which will offer a significant surface area for uniform absorption of microwave irradiation. Due to the absorption of microwave energy, pi-electrons of the carbon black platform will get delocalized electrons to generate sufficient heating enough for the pyrolysis of chemical feedstocks. This strategy will essentially address all the issues mentioned above including the advantage of very-low production costs.

### SUMMARY OF THE INVENTION

The present disclosure seeks to provide a microwave-assisted pyrolysis system and method using a carbon black platform to uniformly absorb microwave irradiation. Microwave energy will delocalize pi-electrons of the carbon black platform, generating enough heat for chemical feedstock to undergo pyrolysis.

In an embodiment, a microwave-assisted pyrolysis system is disclosed. The system includes a microwave chamber body. The system further includes a black carbon platform disposed inside the microwave chamber body for irradiating microwave radiation and absorbing microwave energy. The system further includes a quartz microwave reactor placed on the black carbon platform for receiving chemical precursor(s) and applying microwave irradiation for absorption of microwave energy thereby heating the black carbon platform for microwave-assisted pyrolysis of the received chemical precursor(s). The system further includes a cooling unit employed for regulating and maintaining a user-defined temperature level upon detecting the temperature inside the microwave reactor using a temperature sensor, if the temperature exceeds the optimum level, wherein the optimum temperature is defined on the type of precursors undergoing pyrolysis, wherein if the heating temperature is raised extremely high, the cooling unit inside the microwave machine gets activated to bring down the temperature to the user-defined level.

In another embodiment, a microwave-assisted pyrolysis method is disclosed. The method includes transferring chemical precursor(s) to a quartz microwave reactor. The method further includes placing the quartz microwave reactor on a carbon black platform and thereby applying microwave irradiation for absorption of microwave energy. The method further includes heating the black carbon platform for microwave-assisted pyrolysis of the received chemical precursor(s). The method further includes monitoring temperature and pressure inside the microwave reactor using a temperature sensor and a pressure sensor. The method further includes activating a cooling unit installed inside the microwave machine to bring down the temperature to a user-defined level upon detecting the temperature inside the microwave reactor using the temperature sensor, wherein the heating rate control system already installed in the microwave machine monitors the desired heating rate.

An object of the present disclosure is to receive microwave irradiation uniformly using a black carbon platform.

Another object of the present disclosure is to delocalize the pi-electrons of the black carbon platform to generate sufficient energy.

Another object of the present disclosure is to dispose of uniform heating via generated energy to the targeted chemical feedstocks.

Another object of the present disclosure is to declare that the undergoing pyrolysis of chemical feedstocks is eco-friendly.

Another object of the present disclosure is to ensure an inexpensive suitable, efficient protocol for pyrolysis compared to traditional pyrolysis.

Yet another object of the present invention is to deliver expeditious and cost-effective pyrolysis in minimum time, avoiding the formation of undesirable side products.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of a microwave-assisted pyrolysis system in accordance with an embodiment of the present disclosure;

FIG. 2 illustrates a flow chart of a microwave-assisted pyrolysis method in accordance with an embodiment of the present disclosure;

FIG. 3 illustrates traditional pyrolysis along with challenges in accordance with an embodiment of the present disclosure;

FIG. 4 illustrates microwave-assisted pyrolysis (MAP) in accordance with an embodiment of the present disclosure;

FIG. 5 illustrates a modified MAP, using a carbon black platform in accordance with an embodiment of the present disclosure;

FIG. 6 illustrates a mechanism of pyrolysis to approach the chemical transformation of a chemical feedstock in accordance with an embodiment of the present disclosure; and

FIG. 7 illustrates the advantages of modified MAP over traditional pyrolysis in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

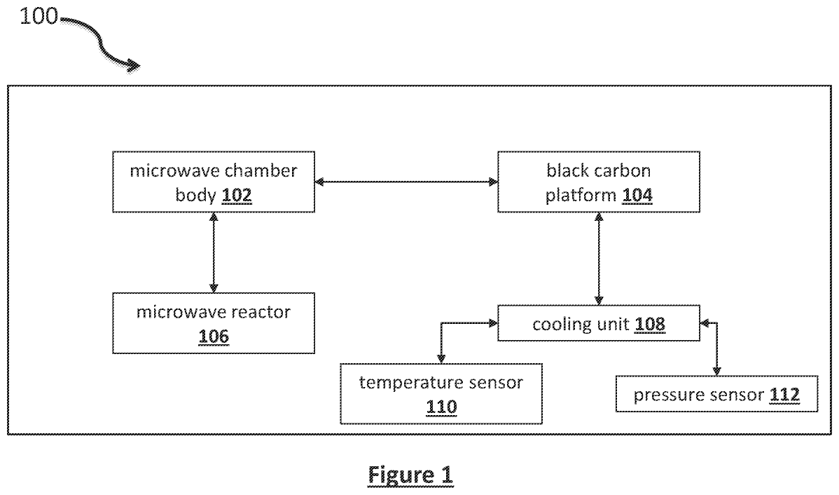

Referring to FIG. 1, a block diagram of a microwave-assisted pyrolysis system is illustrated in accordance with an embodiment of the present disclosure. System 100 includes a microwave chamber body (102).

In an embodiment, a black carbon platform (104) is disposed of inside the microwave chamber body (102) for irradiating microwave radiation and absorbing microwave energy.

In an embodiment, a quartz microwave reactor (106) is placed on the black carbon platform (104) for receiving chemical precursor(s) and applying microwave irradiation for absorption of microwave energy thereby heating the black carbon platform (104) for microwave-assisted pyrolysis of the received chemical precursor(s).

In an embodiment, a cooling unit (108) is employed for regulating and maintaining a user-defined temperature level upon detecting the temperature inside the microwave reactor (106) using a temperature sensor (110), if the temperature exceeds the optimum level, wherein the optimum temperature is defined on the type of precursors undergoing pyrolysis, wherein if the heating temperature is raised extremely high, the cooling unit (108) inside the microwave machine gets activated to bring down the temperature to the user-defined level.

In another embodiment, the system further comprises a pressure sensor (112) placed inside the microwave reactor (106) for detecting pressure inside the microwave reactor (106) to maintain the pressure level inside the microwave reactor (106).

In another embodiment, the adsorption of microwave radiation causes the delocalization of carbon black's pi electrons to provide sufficient heating energy, wherein the microwave energy excites the pi-electrons of the multi-bonded carbon structure of the carbon black platform (104), and the resulting pi-electrons' conduction moment causes extremely high heating, which is sufficient to cause pyrolysis of a reaction material.

In another embodiment, at room temperature, the microwave reactor (106) containing reaction material is put in a carbon black (Vulcan XC 72) platform following which microwave irradiation starts, wherein 500-600° C. is the optimum temperature for pyrolysis to prepare atomically dispersed metal-nitrogen-carbon materials from the precursors (metal, carbon and nitrogen sources).

In another embodiment, the black carbon platform (104) is dried at 30-100° C. before placing into the microwave chamber body (102) for removing moisture from the black carbon platform (104), wherein the black carbon platform (104) increases internal temperature upon receiving the microwave radiation not absorbed by the chemical during chemical transformation.

In another embodiment, the black carbon platform (104) is placed beneath a microwave reactor (106) in which the chemical is poured for the chemical transformation, wherein the size of the black carbon platform (104) selectively larger or equal to the size of the microwave reactor (106).

In another embodiment, the chemical precursors, the feedstock, receive insufficient microwave heating for pyrolysis to take place, wherein after getting microwave energy, pi-electrons of the carbon black platform (104) get delocalized to become red-hot, creating extreme heating.

In another embodiment, to achieve desired pyrolysis, heating of chemical feedstock in the range of 400-600° C. is required, which is monitored by the temperature sensor (110), wherein the parameters selected from temperature, heating rate, reaction environment, and cooling for the chemical transformation is monitored by the microwave machine.

In another embodiment, the microwave chamber body (102) includes a microwave-transparent rotating window, wherein the feedstock channel for acquainting feedstocks with the microwave-straightforward pivoting window is arranged over the microwave-straightforward alternating window.

In one embodiment, a microwave inlet is disposed of, wherein a baffle plate is used to level the feedstocks on the rotating window that is microwave-transparent and to separate the chamber with at least one pyrolysis sector for flash pyrolysis.

In one embodiment, a wet gas outlet is connected to a gas collection unit for collecting wet gas from at least one pyrolysis sector, and the wet gas outlet is disposed of over the microwave-transparent rotating window.

In one embodiment, a dry-end product outlet is connected to the chamber for collecting pyrolyzed dry-end products from the microwave-transparent rotating window.

In one embodiment, a feedstock inlet is connected to the dry-end product outlet for acquainting feedstocks with the microwave-straightforward pivoting window.

In another embodiment, the gas reactor outlet is connected to a gas-solid separator by a pipeline, and the gas-solid separator is used to separate pyrolyzing steam from solid grain, wherein a condenser is equipped with a gas-liquid separator, and the condenser sets are furnished with a gas outlet and a liquid outlet.

In another embodiment, a condenser-air outlet is connected to the gas cleaning plant, an outlet of the gas cleaning plant is connected to the non-condensable gas compression machine and after the condenser liquid outlet connects pyrolysis liquids circulating pump, a road connects the oil storage tank, and the cooled medium in another road follows Loop systems return condenser, wherein the condenser is preferably a spray condenser, after spray condenser connects the pyrolysis liquids circulating pump, with oil storage tank and cooling medium, wherein the spray condenser connects to the oil storage tank via a first road pipeline that has a liquid level adjusting valve door, and spraying in cold condenser connects to the cooling medium circulating pump via a second road pipeline, and the outlet of the cooling medium circulating pump connects to the entrance of the air cooler, wherein the outlet of the cooler returns the spray condenser through the liquid distributor when the air cooler is empty.

In another embodiment, the liquid distributor further returns the spray condenser in two-way, one liquid as the primary pre-cooling nozzle circulation fluid, the Pre-cooled nozzle sprays into the middle part of the spray condenser, and another top jet nozzle through the spray condenser for the one flow follow as coolant ring, wherein the pyrolysis oil is formed in the condenser, after the pressurization of pyrolysis liquids circulating pump, a road enters oil storage tank thereby the spray condenser is returned by air cooler and realizes circulation by the road warp after the filtration of defecator.

In another embodiment, the microwave chamber body (102) is adapted to conduct microwave-assisted torrefaction of biomass material, the microwave chamber body (102) comprises a feed pipe for the transfer of the biomass material with gas and/or liquid outlets to allow rapid removal of gas and/or liquid formed during torrefaction and a material densifier integral with the microwave unit to compress and preheat the biomass material entering the microwave unit.

In another embodiment, a tuning plate equipped with an adjusting mechanism is attached to the microwave chamber body (102) and automatically operated to optimize the microwave field in the pyrolysis sector and to allow maximum microwave energy to enter the feed feedstock and be absorbed by the feedstock feed, with the tuning plate connected to the adjusting mechanism and positioned between the microwave transmitting rotary window and the humid gas outlet, wherein the tuning plate is used to minimize reflected power to the microwave magnetron and to maintain maximum energy efficiency in the pyrolytic sector.

Yet, in another embodiment, a catalytic mesh is coupled to the tuning plate and above the revolving microwave-transparent window, and which is used to further break down chemical bonds and separate chemically bound components in wet pyrolysis gas, wherein the catalytic mesh is selected from Titanium oxides (TiO₂, rutile, anatase), Nickel-Phosphate (Ni₂P), Aluminium oxides (Al₂O₃), Ru—TiO₂, calcium aluminum silicate (CaₐAl_{b}Si_{c}O_{d}), Iron oxides (Hematite, Fe₂O₃, Goethite FeO(OH), Silicium oxides (SiO₂), red mud and combinations thereof, wherein the catalytic mesh comprises an oxide mixture containing 35 to 40% Fe₂O₃, 20 to 25% Al₂O₃, 8 to 18% SiO₂, and 5-10% TiO₂.

In another embodiment, a first pipeline bypass is communicated with the reactor, a condenser is organized on the first pipeline bypass and is utilized for gathering pyrolysis gas produced by the pyrolysis response to get bio-oil wealthy in phenolic compounds, and non-condensable gas circularly enters the reactor, wherein in order to disrupt the microwave absorbent bed layer's transition from a fixed to a fluidized state during the pyrolysis reaction, a second pipeline bypass communicates with the reactor and is used to increase the flow of the carrier gas every 1-3 minutes.

In another embodiment, the flow of the carrier gas is increased during the pyrolysis reaction process every 1-3 minutes to disturb the suspension of the microwave absorbent bed layer from a fixed state to a fluidized state, wherein the time required to maintain the fluidized state of the microwave absorbent bed layer is between 30 seconds and 1 minute.

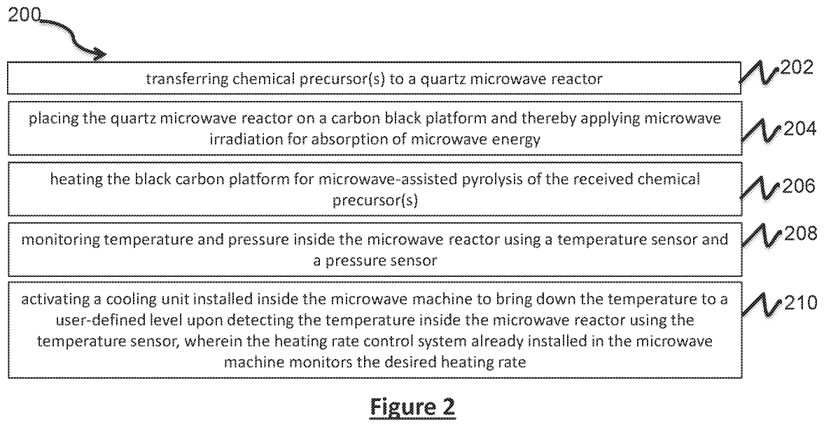

FIG. 2 illustrates a flow chart of a microwave-assisted pyrolysis method in accordance with an embodiment of the present disclosure. At step 202, method 200 includes transferring chemical precursor(s) to a quartz microwave reactor (106).

At step 204, method 200 includes placing the quartz microwave reactor (106) on a carbon black platform (104) and thereby applying microwave irradiation for absorption of microwave energy.

At step 206, method 200 includes heating the black carbon platform (104) for microwave-assisted pyrolysis of the received chemical precursor(s).

At step 208, method 200 includes monitoring temperature and pressure inside the microwave reactor (106) using a temperature sensor (110) and a pressure sensor (112).

At step 210, method 200 includes activating a cooling unit (108) installed inside the microwave machine to bring down the temperature to a user-defined level upon detecting the temperature inside the microwave reactor (106) using the temperature sensor (110), wherein the heating rate control system already installed in the microwave machine monitors the desired heating rate.

In another embodiment, method 200 further comprises utilizing the microwave supplemental pyrolysis for the rapid pyrolysis of a feedstock comprises injecting a feedstock into the chamber through a feedstock inlet and transferring the feedstock through the gap to the pyrolysis sector, wherein the gap exists between the microwave transparent rotary window and the first baffle plate. Then, pyrolyzing the feedstock by up microwave energy coming from the microwave inlet through the microwave transmissive rotational window, wherein the wet pyrolysis gas and the pyrolyzed dry side item are delivered by a quick pyrolysis process. Thereafter, collecting the wet pyrolysis gas passed through the wet gas discharge port using the gas collection device thereby transferring the pyrolyzed dry side product to the dry side product outlet and transferring the pyrolyzed product outside the chamber.

In another embodiment, method 200 further comprises collecting the wet gas by a gas collection unit through a wet gas outlet.

In another embodiment, the heat treatment process comprises adding one or more agents or additives into the chemical precursor(s), then, utilize additives and accessory processes on the substrate to produce an intermediate product. Then, producing a product by transforming the intermediate product through a main process. Thereafter, measuring the substrate and product flow as it moves through at least one of the processes.

In another embodiment, the agents are selected from agents for coupling a driver, agents for catalyst control, suppressants of side effects, materials that make it easier to recover and/or isolate a desired side product, and supplies for assisting in the isolation or elimination of undesirable side effects.

In another embodiment, the reagents are heated by electromagnetic radiation, causing a chemical reaction.

In another embodiment, method 200 further comprises maintaining a negative pressure inside the pyrolysis reactor that is larger than or equal to 600 to 760 millimeters of mercury (mmHg) or atmospheric pressure, and delivering the vapor produced during the pyrolysis of the VDBs to a bed of catalysts, where the vapor is then passed through to be reformed and/or changed.

First of all, the chemical precursor(s) are transferred to a microwave reactor (106) made of quartz, placed on the carbon black platform (104) (a good microwave absorber), and microwave irradiation is applied. Following the absorption of microwave radiation, carbon platforms get red-hot, creating extreme heating. This heat facilitates microwave-assisted pyrolysis. The temperature and pressure inside the microwave reactor are monitored using temperature (110) and pressure sensors (112). If the heating temperature is raised extremely high (beyond threshold limit ranging from 300-400° C.), the cooling unit (108) already installed inside the microwave machine gets activated to bring down the temperature to the desired level. Simultaneously, the heating rate control system already installed in the microwave machine monitors the desired heating rate.

For microwave-assisted pyrolysis, a microwave reactor (106) made of quartz material is used. This reactor (106) is put on a carbon black (Vulcan XC 72) platform, At room temperature, a microwave reactor (106) containing reaction material is put in a carbon black (Vulcan XC 72) platform following which microwave irradiation starts.

Yes, the adsorption of microwave radiation causes the delocalization of carbon black's pi electrons to provide sufficient heating energy. Although microwave energy alone cannot break down chemical bonds, it can excite the pi-electrons of the multi-bonded carbon structure of the carbon black platform (104), and the resulting pi-electrons' conduction moment can cause extremely high heating, which is sufficient to cause pyrolysis of a reaction material.

The chemical precursors, the feedstock, receive insufficient microwave heating for pyrolysis to take place. However, after getting microwave energy, pi-electrons of the carbon black platform (104) (a good microwave absorber) get delocalized to become red-hot, creating extreme heating. To achieve the desired pyrolysis, heating of chemical feedstock in the range of 400-600° C. is required, which is monitored via a temperature sensor. The parameters (temperature, heating rate, reaction environment, and cooling) for the chemical transformation can be monitored by the inbuilt features of the microwave machine.

The optimum temperature depends on the type of precursors undergoing pyrolysis. For example, to prepare atomically dispersed metal-nitrogen-carbon materials from the precursors (metal, carbon, and nitrogen sources), generally 500-600° C. is the optimum temperature for pyrolysis. If the heating temperature is raised extremely high, the in-built cooling system inside the microwave machine gets activated to bring down the temperature to the desired level.

During pyrolysis, fragmentation of chemical species followed by recombination to generate novel material takes place. If, however, the temperature exceeds the optimum level, fragmentation may be such that it is unsuitable for the purpose. Hence, in-built cooling systems work to bring down the temperature to the desired level.

Following the absorption of microwave radiation, carbon platforms get red-hot, creating extreme heating. This heat facilitates microwave-assisted pyrolysis. The temperature inside the microwave reactor (106) is monitored using a temperature sensor. If the heating temperature is raised extremely high, the in-built cooling system inside the microwave machine gets activated to bring down the temperature to the desired level. In addition, the desired thermal temperature for proper chemical transformation depends on the type of precursors undergoing pyrolysis. For example, to prepare atomically dispersed metal-nitrogen-carbon materials from the precursors (metal, carbon, and nitrogen sources), generally 500-600° C. is the optimum temperature for pyrolysis.

The method is focused to replace conventional pyrolysis with an environmentally friendly microwave-assisted pyrolysis machine; the exact calculation of energy consumption is too difficult at this stage. However, the reaction time can be calculated based on the heating rate.

Ideally, any pi-conjugated carbon material capable of absorbing microwave energy, resulting in the delocalization of pi-electrons to generate extreme heating for pyrolysis, is the principal modification MAP in this invention. However, apart from black carbon, an in-built cooling system (108) may be another key modification in the MAP, Additionally, the provision of an inert environment in the microwave reactor (106) during pyrolysis may be another key modification in cases where pyrolysis in the absence of oxygen is desired.

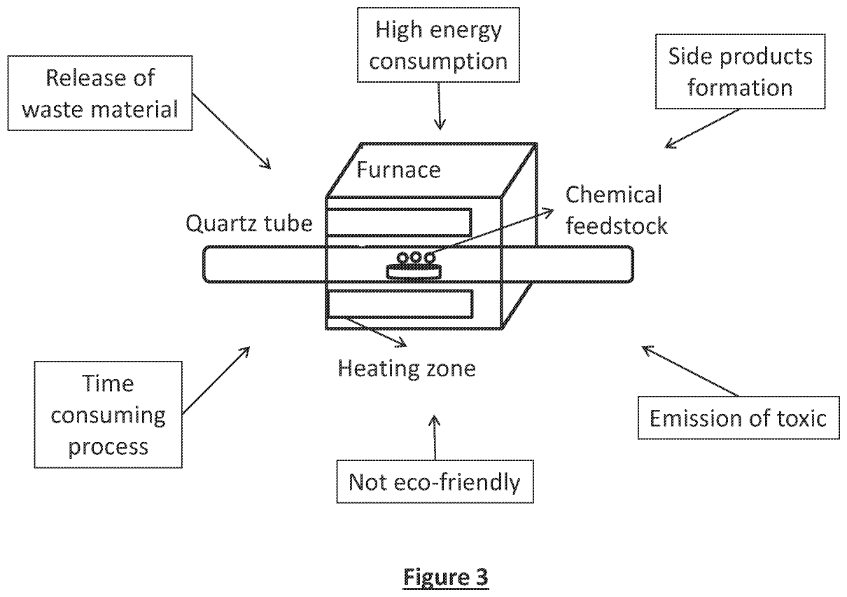

FIG. 3 illustrates traditional pyrolysis along with challenges in accordance with an embodiment of the present disclosure. Generally, traditional pyrolysis involves high-temperature treatment (400-1000° C.), having many disadvantages like high energy (electricity) consumption, the possibility of the formation of undesirable side products, and sometimes unwanted morphological and structural changes in the desired product. In contrast, MAP is a suitable alternative option to traditional pyrolysis. However, in case a very high temperature is needed to conduct the chemical transformation in MAP, it becomes practically extremely difficult to reach such a high temperature following the convection mechanism. To overcome this issue, an extended approach can be adopted, which involves the use of a carbon black platform (104) in a microwave furnace, which on being exposed to microwave irradiation gets excited by absorbing MW energy, which in turn facilitates the conversion of desired reaction by attaining desired temperature.

FIG. 3 shows the components, parameters, and challenges of the traditional pyrolysis strategy.

When a black carbon platform (104) (good microwave absorber) is placed in a microwave base and irradiated microwave radiation, it absorbs microwave energy and gets excited attaining a very high temperature, required for the pyrolysis of desired material to conduct the chemical transformation. In due course of time, the chemical transformation gets completed with the desired product. It is critical here to monitor the reaction temperature and pressure to make desired thermal temperature available. If the temperature exceeds the optimum temperature, a suitable cooling unit (108) may be installed to monitor the temperature.

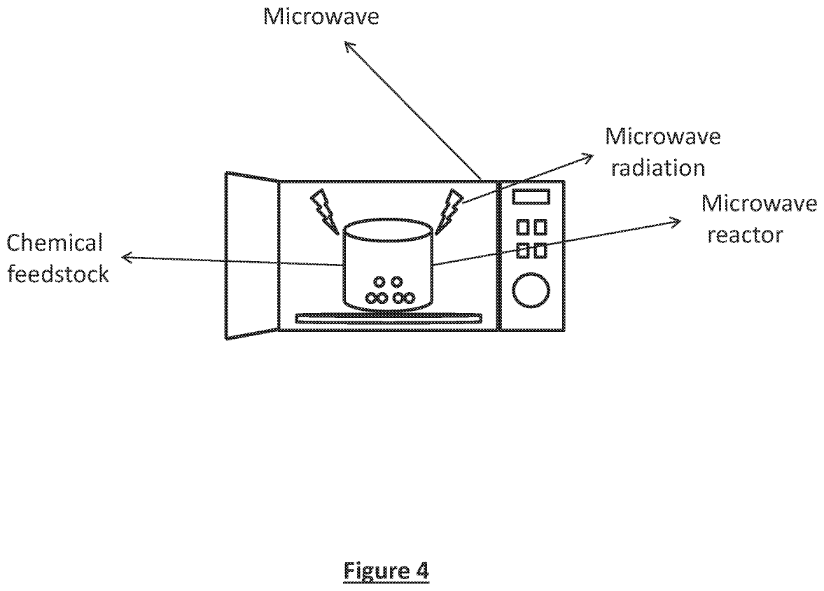

FIG. 4 illustrates microwave-assisted pyrolysis (MAP) in accordance with an embodiment of the present disclosure. FIG. 4 shows the components, parameters, and challenges of the MAP approach.

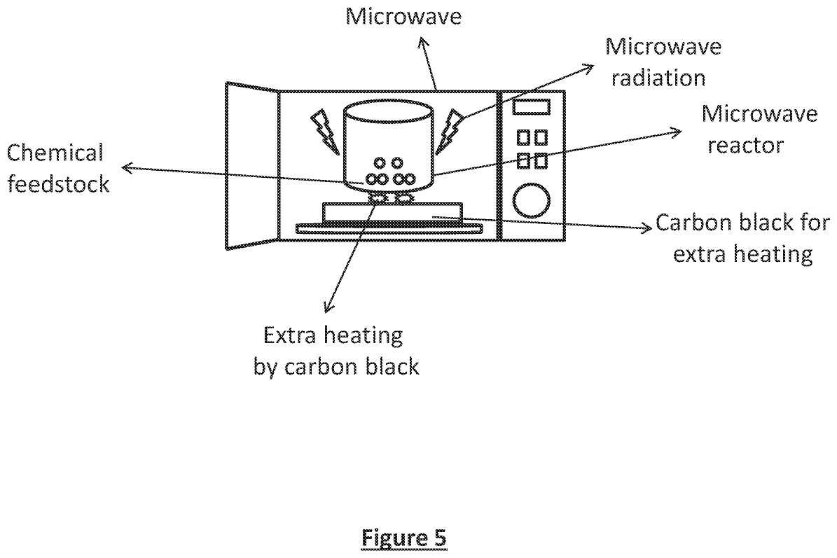

FIG. 5 illustrates a modified MAP, using a carbon black platform in accordance with an embodiment of the present disclosure. FIG. 5 shows how the carbon black platform (104) can be utilized to overcome the issues with MAP.

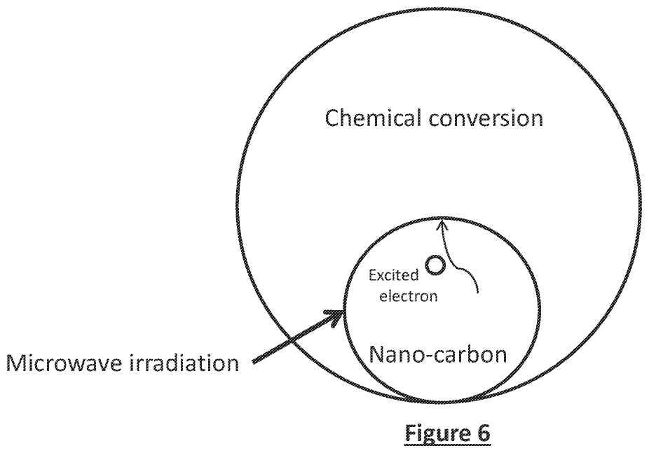

FIG. 6 illustrates a mechanism of pyrolysis to approach the chemical transformation of a chemical feedstock in accordance with an embodiment of the present disclosure, FIG. 6 shows the mechanism to approach a chemical transformation in the carbon black-assisted heating in MAP.

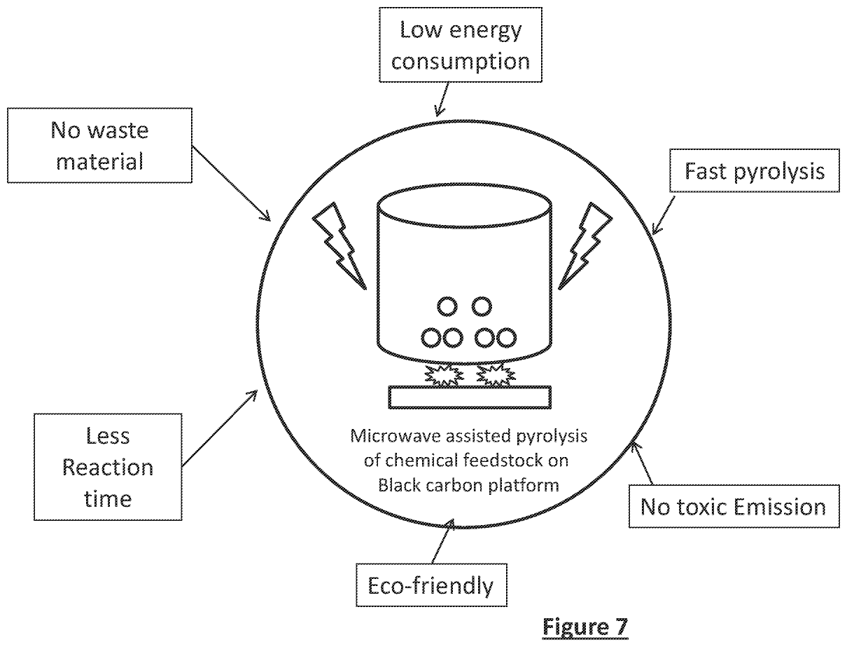

FIG. 7 illustrates the advantages of modified MAP over traditional pyrolysis in accordance with an embodiment of the present disclosure. FIG. 7 explored the probable features of MAP with a black carbon platform (104).

The system seeks to provide a strategy to replace the traditional pyrolysis approach with a suitable alternative modified MAP protocol. The system discloses the use of a black carbon platform (104) to receive microwave irradiation uniformly. The system further state that by microwave irradiation, the pi-electrons of the black carbon platform (104) get delocalized to generate sufficient energy. The system discloses the uniform heating via generated energy to the targeted chemical feedstocks by convection mechanism. The system declares that the undergoing pyrolysis of chemical feedstocks is eco-friendly. The process ensures cost-effective pyrolysis in minimum time, avoiding the formation of undesirable side products, Finally, this process will ensure an inexpensive suitable, and efficient protocol for pyrolysis compared to traditional pyrolysis.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A microwave-assisted pyrolysis system, the system comprises:
a microwave chamber body (102);
a black carbon platform (104) disposed inside the microwave chamber body (102) for irradiating microwave radiation and absorbing microwave energy;
a quartz microwave reactor (106) placed on the black carbon platform (104) for receiving chemical precursor(s) and applying microwave irradiation for absorption of microwave energy thereby heating the black carbon platform (104) for microwave-assisted pyrolysis of the received chemical precursor(s);
a cooling unit (108) employed for regulating and maintaining a user-defined temperature level upon detecting the temperature inside the microwave reactor (106) using a temperature sensor (110), if the temperature exceeds the optimum level, wherein the optimum temperature is defined on the type of precursors undergoing pyrolysis; and
wherein if the heating temperature reached beyond a threshold ranging from 300-400° C., the cooling unit (108) inside the microwave machine gets activated to bring down the temperature to the user-defined level, wherein the gas reactor outlet is connected to a gas-solid separator by a pipeline, and the gas-solid separator is used to separate pyrolyzing steam from solid grain, wherein a condenser is equipped with a gas-liquid separator, and the condenser sets are furnished with a gas outlet and a liquid outlet, and wherein a condenser-air outlet is connected to the gas cleaning plant, an outlet of the gas cleaning plant is connected to the non-condensable gas compression machine and after the condenser liquid outlet connects pyrolysis liquids circulating pump, a road connects the oil storage tank, and the cooled medium in another road follows Loop systems return condenser, wherein the condenser is preferably a spray condenser, after spray condenser connects the pyrolysis liquids circulating pump, with oil storage tank and cooling medium, wherein the spray condenser connects to the oil storage tank via a first road pipeline that has a liquid level adjusting valve door, and spraying in cold condenser connects to the cooling medium circulating pump via a second road pipeline, and the outlet of the cooling medium circulating pump connects to the entrance of the air cooler, wherein the outlet of the cooler returns the spray condenser through the liquid distributor when the air cooler is empty.

2. The system as claimed in claim 1, wherein the system further comprises a pressure sensor (112) placed inside the microwave reactor (106) for detecting pressure inside the microwave reactor (106) to maintain the pressure level inside the microwave reactor (106).

3. The system as claimed in claim 1, wherein the adsorption of microwave radiation causes the delocalization of carbon black's pi electrons to provide sufficient heating energy, wherein the microwave energy excites the pi-electrons of the multi-bonded carbon structure of the carbon black platform (104), and the resulting pi-electrons' conduction moment causes extremely high heating, which is sufficient to cause pyrolysis of a reaction material.

4. The system as claimed in claim 1, wherein at room temperature, the microwave reactor (106) containing reaction material is put in a carbon black (Vulcan XC 72) platform following which microwave irradiation starts, wherein 500-600° C. is the optimum temperature for pyrolysis to prepare atomically dispersed metal-nitrogen-carbon materials from the precursors (metal, carbon and nitrogen sources).

5. The system as claimed in claim 1, wherein the black carbon platform (104) is dried at 30-100° C. before placing into the microwave chamber body (102) for removing moisture from the black carbon platform (104), wherein the black carbon platform (104) increases internal temperature upon receiving the microwave radiation not absorbed by the chemical during chemical transformation.

6. The system as claimed in claim 1, wherein the black carbon platform (104) is placed beneath a microwave reactor (106) in which the chemical is poured for the chemical transformation, wherein the size of the black carbon platform (104) is selectively larger or equal to the size of the microwave reactor (106).

7. The system as claimed in claim 1, wherein the chemical precursors, the feedstock, receive insufficient microwave heating for pyrolysis to take place, wherein after getting microwave energy, pi-electrons of carbon black platform (104) get delocalized to become red-hot, creating extreme heating.

8. The system as claimed in claim 1, wherein to achieve desired pyrolysis, heating of chemical feedstock in the range of 400-600° C. is required, which is monitored by the temperature sensor (110), wherein the parameters selected from temperature, heating rate, reaction environment, and cooling for the chemical transformation is monitored by the microwave machine.

9. The system as claimed in claim 1, wherein the microwave chamber body (102) comprises:
a microwave-transparent rotating window, wherein the feedstock channel for acquainting feedstocks with the microwave-straightforward pivoting window is arranged over the microwave-straightforward alternating window;
a microwave inlet, wherein a baffle plate is used to level the feedstocks on the rotating window that is microwave-transparent and to separate the chamber with at least one pyrolysis sector for flash pyrolysis;
a wet gas outlet connected to a gas collection unit for collecting wet gas from at least one pyrolysis sector and the wet gas outlet is disposed over the microwave-transparent rotating window;
a dry-end product outlet connected to the chamber for collecting pyrolyzed dry-end products from the microwave-transparent rotating window; and
a feedstock inlet for acquainting feedstocks with the microwave-straightforward pivoting window.

10. The system as claimed in claim 1, wherein the liquid distributor further returns the spray condenser by two-way, one liquid as the primary pre-cooling nozzle circulation fluid, Pre-cooled nozzle sprays into the middle part of the spray condenser and another top jet nozzle through spray condenser for the one flow follows as coolant ring, wherein the pyrolysis oil is formed in the condenser, after the pressurization of pyrolysis liquids circulating pump, a road enters oil storage tank thereby the spray condenser is returned by air cooler and realizes circulation by the road warp after the filtration of defecator.

11. The system as claimed in claim 1, wherein the microwave chamber body (102) is adapted to conduct microwave-assisted torrefaction of biomass material, the microwave chamber body (102) comprises:
a feed pipe for the transfer of the biomass material with gas and/or liquid outlets to allow rapid removal of gas and/or liquid formed during torrefaction; and
a material densifier integral with the microwave unit to compress and preheat the biomass material entering the microwave unit.

12. The system as claimed in claim 1, wherein a tuning plate equipped with an adjusting mechanism is attached to the microwave chamber body (102) and automatically operated to optimize the microwave field in the pyrolysis sector and to allow maximum microwave energy to enter the feed feedstock and be absorbed by the feedstock feed, with the tuning plate connected to the adjusting mechanism and positioned between the microwave transmitting rotary window and the humid gas outlet, wherein the tuning plate is used to minimize reflected power to the microwave magnetron and to maintain maximum energy efficiency in the pyrolytic sector.

13. The system as claimed in claim 1, further comprises a catalytic mesh coupled to the tuning plate and above the revolving microwave-transparent window, which is used to further break down chemical bonds and separate chemically bound components in wet pyrolysis gas, wherein the catalytic mesh is selected from Titanium oxides (TiO₂, rutile, anatase), Nickel-Phosphate (Ni₂P), Aluminium oxides (Al₂O₃), Ru—TiO₂, calcium aluminum silicate (CaₐAl_{b}Si_{c}O_{d}), Iron oxides (Hematite, Fe₂O₃, Goethite FeO(OH), Silicium oxides (SiO₂), red mud and combinations thereof, wherein the catalytic mesh comprises an oxide mixture containing 35 to 40% Fe₂O₃, 20 to 25% Al₂O₃, 8 to 18% SiO₂, and 5-10% TiO₂.

14. The system as claimed in claim 1, wherein a first pipeline bypass is communicated with the reactor, and a condenser is organized on the first pipeline bypass and is utilized for gathering pyrolysis gas produced by the pyrolysis response to get bio-oil wealthy in phenolic compounds, and non-condensable gas circularly enter the reactor, wherein in order to disrupt the microwave absorbent bed layer's transition from a fixed to a fluidized state during the pyrolysis reaction, a second pipeline bypass communicates with the reactor and is used to increase the flow of the carrier gas every 1-3 minutes.

15. The system as claimed in claim 1, wherein the flow of the carrier gas is increased during the pyrolysis reaction process every 1-3 minutes to disturb the suspension of the microwave absorbent bed layer from a fixed state to a fluidized state, wherein the time required to maintain the fluidized state of the microwave absorbent bed layer is between 30 seconds and 1 minute.

16. A microwave-assisted pyrolysis method, the method comprises:
transferring chemical precursor(s) to a quartz microwave reactor (106);
placing the quartz microwave reactor (106) on a carbon black platform (104) and thereby applying microwave irradiation for absorption of microwave energy;
heating the black carbon platform (104) for microwave-assisted pyrolysis of the received chemical precursor(s);
monitoring temperature and pressure inside the microwave reactor (106) using a temperature sensor (110) and a pressure sensor (112); and
activating a cooling unit (108) installed inside the microwave machine to bring down the temperature to a user-defined level upon detecting the temperature inside the microwave reactor (106) using the temperature sensor (110), wherein the heating rate control system already installed in the microwave machine monitors the desired heating rate.

17. The method as claimed in claim 16, further comprises utilizing the microwave supplemental pyrolysis for the rapid pyrolysis of a feedstock comprises:
injecting a feedstock into the chamber through a feedstock inlet and transferring the feedstock through the gap to the pyrolysis sector, wherein the gap exists between the microwave transparent rotary window and the first baffle plate;
pyrolyzing the feedstock by up microwave energy coming from the microwave inlet through the microwave transmissive rotational window, wherein the wet pyrolysis gas and the pyrolyzed dry side item are delivered by a quick pyrolysis process; and
collecting the wet pyrolysis gas passed through the wet gas discharge port using the gas collection device thereby transferring the pyrolyzed dry side product to the dry side product outlet and transferring the pyrolyzed product outside the chamber.

18. The method as claimed in claim 16, further comprises collecting the wet gas by a gas collection unit through a wet gas outlet, and wherein the heat treatment process comprises:
adding one or more agents or additives into the chemical precursor(s);
utilizing additives and accessory processes on the substrate to produce an intermediate product;
producing a product by transforming the intermediate product through a main process; and
measuring the substrate and product flow as it moves through at least one of the processes.

19. The method as claimed in claim 16, wherein the agents are selected from agents for coupling a driver, agents for catalyst control, suppressants of side effects, materials that make it easier to recover and/or isolate a desired side product, and supplies for assisting in the isolation or elimination of undesirable side effects, and wherein the reagents are heated by electromagnetic radiation, causing a chemical reaction.

20. The method as claimed in claim 16, further comprises:
maintaining a negative pressure inside the pyrolysis reactor that is larger than or equal to 600 to 760 millimeters of mercury (mmHg) or atmospheric pressure; and
delivering the vapor produced during the pyrolysis of the VDBs to a bed of catalysts, where the vapor is then passed through to be reformed and/or changed.
